(19) United States
(12) Patent Application Publication
(10) Pub. No.: US 2023/0148740 A1
(43) Pub. Date: May 18, 2023

(54) RECONFIGURABLE CLEANING BRUSH WITH ROTATABLE BRUSH HEAD

(71) Applicant: Creative Hat, Inc., Springfield, MA (US)

(72) Inventor: Mario E. Magnani, Springfield, MA (US)

(21) Appl. No.: 17/881,808

(22) Filed: Aug. 5, 2022

Related U.S. Application Data
(63) Continuation-in-part of application No. 16/688,285, filed on Nov. 19, 2019, now Pat. No. 11,607,031.
Application No. 16/688,285 is a continuation-in-part of application No. PCT/US2018/033687, filed on May 21, 2018.
(60) Provisional application No. 63/229,685, filed on Aug. 5, 2021.
(60) Provisional application No. 62/508,737, filed on May 19, 2017.

(51) Int. Cl. A46B 5/00; B25G 3/02

(52) U.S. Cl. CPC A46B 5/0054; B25G 3/02; A46B 2200/30

(57) ABSTRACT

A reconfigurable brush includes an elongated brush head extending between brush-head first and second ends and a brush handle extending between handle proximate and distal ends. The brush-head first end is mounted to the handle distal end for rotation about a brush-head rotation axis between opposed first and second angular orientations and axial displacement along the brush-head rotation axis between opposed axial first and second positions. The first and second angular orientations are defined such that the brush-head second end is disposed, respectively, (i) rearwardly of the brush-head first end and the handle distal end and (ii) forwardly of the brush-head first end and the handle distal end. The axial first and second positions correspond to the handle being, respectively, (a) locked in one of the first and second angular orientations and (b) unlocked to allow rotation between the opposed first and second angular orientations.

### CROSS-REFERENCE TO RELATED APPLICATIONS/PRIORITY CLAIMS

The present application claims priority in two separate chains of previous applications disclosed hereinbelow.

Most immediately, priority based on Provisional Application Ser. No. 63/229,686 filed Aug. 5, 2021, and titled “RECONFIGURABLE CLEANING BRUSH WITH ROTATABLE BRUSH HEAD” is claimed. Moreover, the entirety of the previous provisional application, including the drawings, is incorporated herein by reference as if set forth fully in the present application.

In addition to the above, priority is also claimed in the entire application chain that includes U.S. application Ser. No. 16/688,285 filed Nov. 19, 2019 under the title “RECONFIGURABLE MODULAR BRUSH AND ASSOCIATED BRUSH KITS,” and of which the present application is filed as a continuation-in-part. application Ser. No. 16/688,285 was filed as a continuation-in-part of International Application Serial No. PCT/US2018/033687 filed May 21, 2018 pursuant to the Patent Cooperation Treaty, and under the title “RECONFIGURABLE MODULAR BRUSH AND ASSOCIATED BRUSH KITS.” Application PCT/US2018/033687 claimed priority benefits in U.S. Provisional Application No. 62/508,737 filed May 19, 2017 under the title “RECONFIGURABLE MODULAR BRUSH AND ASSOCIATED BRUSH KITS.”

The present application claims the benefit of the filing dates of Provisional Application Ser. No. 62/508,737, PCT Application No. PCT/US2018/033687, and U.S. application Ser. No. 16/688,285 based on the priority chain outlined above. Moreover, the entireties of the disclosures, including the drawings, of all previous applications in the aforesaid priority chain are incorporated herein by reference as if set forth fully in the present application.

To the extent that there is overlap in subject matter between the present application and that disclosed in applications of the longer priority chain including application Ser. No. 16/688,285, it is limited, and relevant only to particular points of novelty asserted in the present application. This fact is the reason for not reiterating herein the cumulative entirety of text and drawings contained in the aforesaid priority chain and relying instead relying on incorporation by reference.

### BACKGROUND

Various existing brushes designed for different cleaning and surface preparation purposes are disparately configured. Common elements among them, however, include a brush head defined by a brush-head block. The brush-head block includes a brush-head lower surface from which protrudes a plurality of bristles. In a first, “traditional scrub brush” configuration, a handle is disposed above the brush-head block with space sufficient between the handle and the brush-head block to accommodate the fingers of a hand grasping the handle. This design allows a user grasping the handle to is apply a maximum of force “downward” onto the brush head, and associated bristles, for scrubbing tasks requiring same (e.g., scrubbing a tub). In a second configuration, a handle is disposed behind and in-line with the brush head. While this second configuration reduces the ability to apply maximum force to the brush head, it does extend the reach of the brush, allowing a user to access areas that would otherwise be less accessible by brushes of the first configuration.

A user wishing to perform different cleaning tasks would traditionally need a set of brushes including brushes of various configurations, such as the first and second configurations described above. Accordingly, a need exists for a single brush that can be reconfigured to serve—alternatively— the functions of either of the first and second configurations of the handled brushes described above.

### SUMMARY

In a first embodiment generally illustrative of the invention, a reconfigurable brush includes two main components: an elongated brush head and an elongated brush handle. The brush head includes a brush-head block having and defining brush-head upper and lower surfaces extending longitudinally along a brush-head axis between brush-head first and second ends. Retained within and protruding downwardly from the brush-head lower surface is at least one bristle array including a plurality of bristles, each of the bristles terminating in a bristle tip for engaging a work surface.

The brush handle has a lengthwise extent disposed generally along a handle axis between a handle proximate end and a handle distal end. For purposes of establishing directional orientation throughout the specification and claims, the handle distal end is regarded as being disposed forwardly of the handle proximate end.

The brush-head first end is mounted to the handle distal end for selective rotation of the brush head about a fixed brush-head rotation axis between first and second angular orientations. The first and second angular orientations are defined such that, in the first angular orientation, the brush-head second end is disposed rearwardly of both the brush-head first end and the handle distal end, and, in the second angular orientation, the brush-head second end is disposed forwardly of both the brush-head first end and the handle distal end. Illustratively embodied, the first and second angular orientations are mutually opposed at an angle of 180 degrees. That is, in moving from the first angular orientation to the second angular orientation, the brush head subtends an angle of 180 degrees about (i.e., centered on) the brush-head rotation axis. Portions of—or mechanical elements depending from—each of the brush handle and the brush head are “complementarily keyed” in a manner that defines the first and second angular orientations and facilitates “locking” of the brush head relative to the brush handle into each of these angular orientations. As will be appreciated more fully through examination of the drawings and reading of the detailed description, the reconfigurable brush is generally configured such that the brush-head rotation axis is oriented substantially orthogonal to the handle axis and, by definition, the overall lengthwise extent of the handle. By “substantially orthogonal” is meant closer to perpendicular than parallel to the handle axis.

In addition to being rotatable about the brush-head rotation axis, the brush head is mounted to the handle in a manner that facilitates its selective axial displacement along the brush-head rotation axis between axial first and second positions. In the axial first position, the brush head is engaged in an interference fit with the brush handle in one of the first and second angular orientations. In the axial second position, the brush head is disengaged from the interference fit with the brush handle such that the brush head can be rotated about the brush-head rotation axis between the first and second angular orientations. In each of various principal embodiments, the brush-head rotation axis is the only axis along which the brush head and brush handle are mutually linearly displaceable or about which they are angularly displaceable relative to one another.

In at least one version, the brush head is normally mechanically biased toward the axial first position in which the brush head and handle are mutually “locked” in one of the first and second angular orientations. Accordingly, an external force axially opposed to the normal mechanical bias must be larger in magnitude along the brush-head rotation axis in order to displace the brush head into the second axial position and allow rotation of the brush head about the brush-head rotation axis.

The disposition of the brush head relative to the brush handle in each of the first and second angular orientations corresponds to the brush assuming two alternative configurations corresponding to two different brush types with different functions. Accordingly, reconfigurability of the brush essentially renders the brush a 2-in-1 brush. More specifically, disposition of the brush head in the first angular orientation corresponds to the reconfigurable brush being in a “traditional” scrub brush configuration in which a majority of the lengthwise extent of the brush head is disposed beneath a majority of the lengthwise extent of the brush handle. Distinguishably, disposition of the brush head in the second angular orientation corresponds to the reconfigurable brush being in an elongated scrub brush configuration in which a majority of the lengthwise extent of the brush head is disposed forwardly of, but still below, a majority of the lengthwise extent of the brush handle.

Among alternative embodiments, the brush head includes bristles varying in length, thickness, coarseness, and material, for example. Moreover, in some versions, the bristles of a single brush head are arranged in disparate bristle arrays comprised of mutually disparate bristles. Bristle arrays comprising bristles of disparate types, sizes, and materials facilitate use of brushes of the general type disclosed in a broader scope of applications, from general cleaning and scrubbing of surfaces, to surface preparation for painting, for example.

In addition, each of various embodiments may include a brush head in which the brush-head first and second ends are disparately configured, as well as the bristle array and bristles at each of those ends relative to the configuration of the bristles at the other end. In one illustrative configuration, including that depicted among several of the drawings, the brush head and bristle array are wider at the brush-head first end than they are at the brush-head second end. Accordingly, when the brush head is in the first angular orientation so that the brush is configured as a traditional scrub brush, and is held in a user's hand with the handle distal end forward of the handle proximate end, the wider portion of the bristle array leads the narrower portion thereof. Behind the intentionality of this configuration is the fact that, in a scrubbing configuration, more downward force is typically exerted on the leading bristles, and distribution of that force over a larger area and a greater number of bristles is advantageous to specific functionality and brush-head longevity. Conversely, when the brush head is in the second angular orientation, the brush-head second end, where the brush head and bristle array are narrower, serves as the leading end of the brush. This configuration is advantageous to accessing corners and crevices while sweeping or even washing, for example. Additionally, it is more difficult to apply a downwardly directed force of high magnitude on the forwardmost bristles in the second orientation, so distribution of force over a smaller area and smaller number of bristles is appropriate/acceptable so that adequate pressure (pressure=force/area) is applied to the work surface.

While the summary, detailed description, and drawings of alternative embodiments are focused principally on brushes including brush heads, embodiments alternative to brushes are envisioned. For instance, in one alternative set of envisioned embodiments, the brush head is substituted by a more broadly defined “working head.” In one version, the working head is configured for removably retaining a surface-abrading material such as sand paper or a sanding sponge with, for example, hook-and-loop fasteners or adhesive. In such as case, the working head might be more specifically referred to as a “sanding head.”

Because a brush head falls within the scope of a more broadly defined working head, and the examples depicted in the drawings and discussed in the detailed description revolve around brushes, these explanatory paragraphs, in addition to the specific examples depicted and described in the detailed description relative to brush heads, provide sufficient enabling disclosure to one of ordinary skill in the art to which the invention pertains. Moreover, the overall specification would support claims reciting more broadly defined “working heads” that can include within their scope both brush heads and the alternatives to brush heads disclosed above (e.g., sanding heads). Relative to embodiments in which heads other than brush heads are employed, the overall tool may be referred to simply as a “reconfigurable surface-engaging tool with a rotatable working head.”

Relative to a “working head,” it is to be understood that portions and components of a working head are disclosed by analogy or extension in the detailed description relative to brush heads. So, by way of non-exclusive example, whereas the detailed description expressly discloses portions such as “brush-head block,” “brush-head upper and lower surfaces,” and “brush-head first and second ends,” it is to be understood by the reader that, as applied to a “working head,” these elements should be conceptualized as “working-head block,” “working-head upper and lower surfaces,” and “working-head first and second ends.” As applied to a sanding head, these elements should be conceptualized as “sanding-head block,” “sanding-head upper and lower surfaces,” and “sanding-head first and second ends.” Similarly, “brush-head rotation axis” becomes “working-head rotation axis” or “sanding-head rotation axis,” etc.

Conceptualized as a sanding tool, with the exception of the bristles and bristle array(s), all other elements of various embodiments would correspond identically to the brush examples depicted and described. The main difference would appear below the brush-head block/sanding-head block where, instead of bristles, the sanding-head lower surface would have an area and attaching elements for attaching a sanding element such as sand paper or a sanding sponge. The attaching elements might include hook-and-loop fasteners such as those of the type commonly sold under the trademark “Velcro®.”

Representative embodiments are more completely described and depicted in the is following detailed description and the accompanying drawings.

### BRIEF DESCRIPTION OF THE DRAWINGS

FIG. 1 is a left-front perspective view of a reconfigurable brush including a brush head and a brush handle in a first configuration, wherein the brush head is selectively rotatable relative to the brush handle;

FIG. 2 is a right-front perspective view of the reconfigurable brush shown in FIG. 1 wherein the brush head has been rotated such that the brush is in a second configuration;

FIG. 3 is a perspective view of the brush head being rotated relative to the brush handle to bring the reconfigurable brush depicted in FIGS. 1 and 2 from the second configurable of FIG. 2 into the first configuration of FIG. 1;

FIG. 4 depicts the brush head and brush handle of the brush of FIGS. 1-3 separated from one another in order to reveal internal components;

FIG. 5 is an exploded view of the reconfigurable brush of FIGS. 1-4;

FIG. 6 is an assembled transparent view of the reconfigurable brush of FIGS. 1-5 with the brush head and brush handle between the first and second configurations; and

FIG. 7 is an assembled transparent view of the reconfigurable brush of FIGS. 1-6 with the brush head and brush handle locked in the first and second configuration.

### DETAILED DESCRIPTION

The following description of a variously configured reconfigurable brush is demonstrative in nature and is not intended to limit the invention or its application of uses. Accordingly, the various implementations, aspects, versions and embodiments described in the summary and detailed description are in the nature of non-limiting examples falling within the scope of the appended claims and do not serve to restrict the maximum scope of the claims.

Shown in the included drawings are various views of an illustrative reconfigurable brush generally referenced by the reference number 10. Throughout the specification and drawings, like elements across alternative embodiments are referenced by similar or identical numeric and/or alphanumeric reference characters.

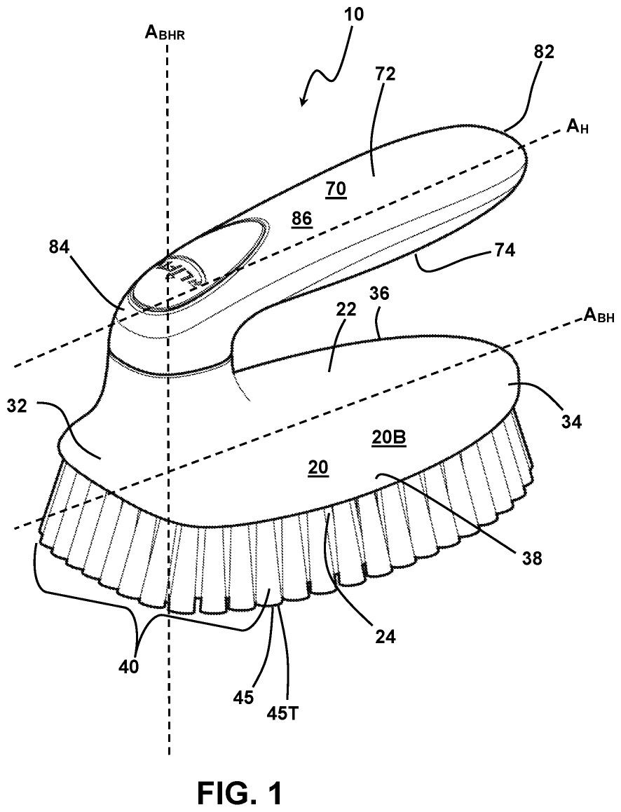

With initial reference to the assembled views of FIG. 1-3, an illustrative first embodiment of a reconfigurable brush 10 includes two main components: an elongated bristle-retaining brush head 20 (alternatively referred to as “brush head 20”) and an elongated brush handle 70. The brush head 20 includes a brush-head block 20B having and defining brush-head upper and lower surfaces 22 and 24 extending longitudinally along a brush-head axis A_{BH} between brush-head first and second ends 32 and 34. Additionally, extending between the brush-head upper and lower surfaces 22 and 24, and longitudinally along the brush-head axis A_{BH} between brush-head first and second ends 32 and 34 are laterally opposed brush-head first and second sides 36 and 38. Retained within and protruding downwardly from the brush-head lower surface 24 is at least one bristle array 40 including a plurality of bristles 45, each of which bristles 45 terminates in a bristle tip 45T for engaging a work surface (not shown).

With continued initial reference to FIGS. 1-3, the brush handle 70 has brush-handle top and bottom surfaces 72 and 74 which, while contoured, have a lengthwise extent disposed generally along a handle axis A_{H} between handle proximate and distal ends 82 and 84. As indicated in the summary, for purposes of establishing directional orientation throughout the specification and claims, the handle distal end 84 is regarded as being disposed forwardly of the handle proximate end 82. The brush handle 70 further includes a grip portion 86 configured for grasping by a human hand and is extending between the handle proximate and distal ends 82 and 84.

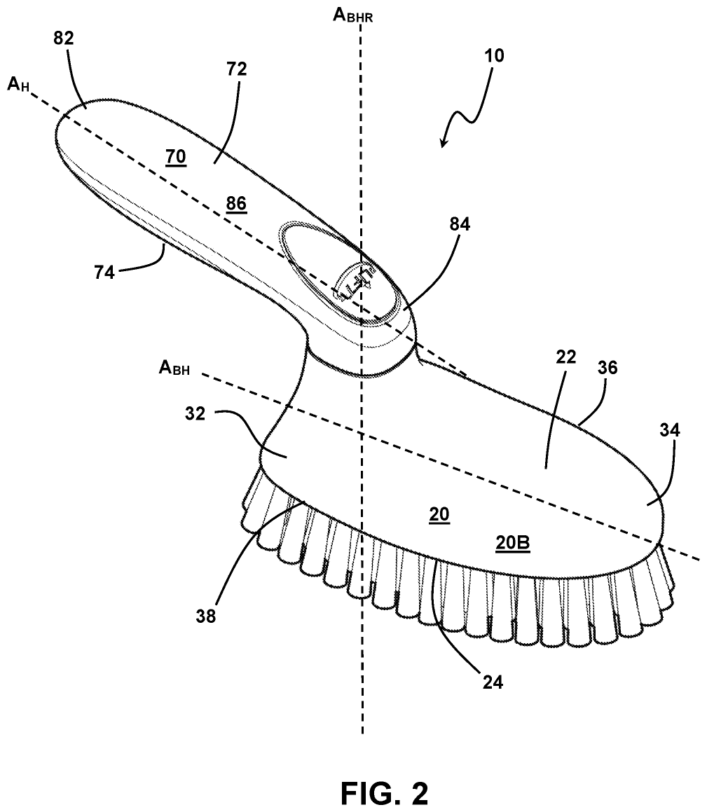

The brush-head first end 32 is mounted to the handle distal end 84 for selective rotation about a brush-head rotation axis A_{BHR} between first and second angular orientations as shown in, respectively, FIGS. 1 and 2. The first angular orientation is defined such that the brush-head second end 34 is disposed rearwardly of both the brush-head first end 32 and the handle distal end 84, as well as the brush-head rotation axis A_{BHR}. The second angular orientation is defined such that the brush-head second end 34 is disposed forwardly of both the brush-head first end 32 and the handle distal end 84, as well as the brush-head rotation axis A_{BHR}. The relative terms “rearward of” and “forward of” are defined with respect to a user of the brush 10 but also, in more “self-contained” and universally applicable terms, with reference to the handle proximate end 82, which is always regarded as rearward of the handle distal end 84, irrespective of how a user is holding the brush 10 at any given time.

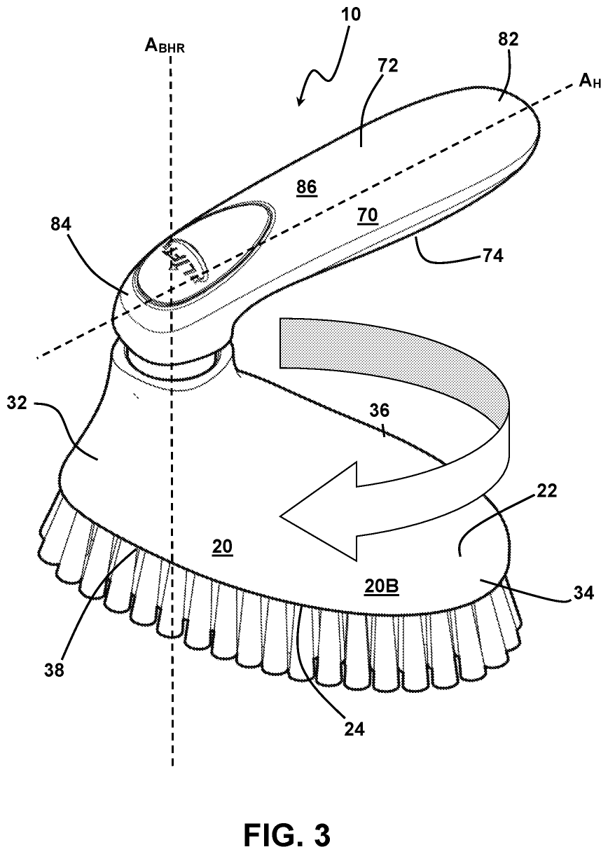

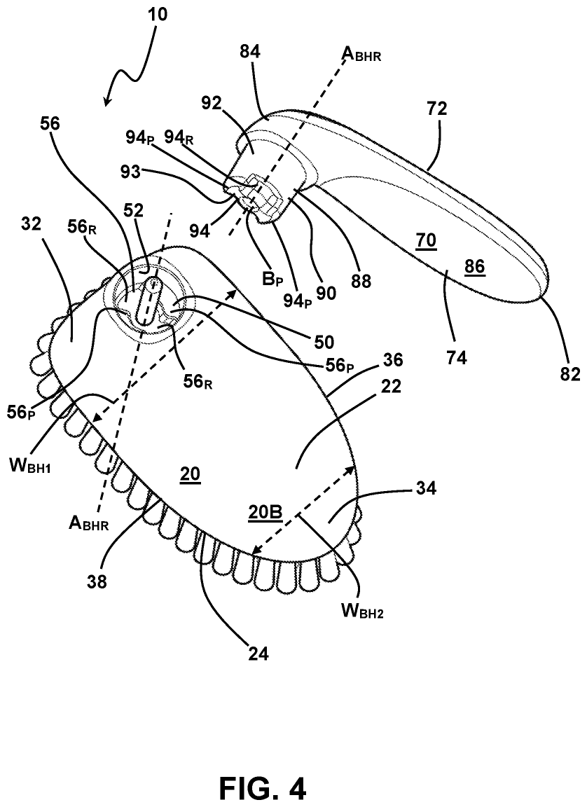

The illustrative first and second angular orientations of FIGS. 1 and 2 are mutually opposed at an angle of 180 degrees. That is, in moving from the first angular orientation to the second angular orientation, the brush head 20 subtends an angle of 180 degrees about (i.e., centered on) the brush-head rotation axis A_{BHR}. FIG. 3 indicates relative rotation between the brush head 20 and the brush handle 70 and, more specifically, angular displacement from the second angular orientation toward the first angular orientation. With reference to FIGS. 4-7, illustrative components for facilitating relative rotation between the brush head 20 and the brush handle 70, and for selectively locking the brush head 20 and brush handle 70 into each of the first and second angular orientations, are described. Integral with or otherwise depending from the grip portion 86 is a brush-head mount 88. The brush-head mount 88 at least partially defines the handle distal end 84 and includes a barrel structure 90 with an interior barrel surface 91, and exterior cylindrical mounting surface 92, and a lower-end wall 93 with lower-wall exterior surface and interior surfaces 94 and 96. The cylindrical mounting surface 92 is axially centered about, and partially defines, the brush-head rotation axis A_{BHR}.

Defined within the brush-head upper surface 22 is a handle socket 50 configured for selectively receiving the brush-head mount 88. More specifically, the handle socket 50 is defined by an interior cylindrical socket surface 52 and a lower socket wall 56. The cylindrical socket surface 52 is configured to receive and retain the cylindrical mounting surface 92 of the brush-head mount 88 in a manner that facilitates relative rotation and axial displacement of the barrel structure 90 and the cylindrical socket surface 52, but prevents relative lateral motion between the barrel structure 90 and the handle socket 50. In essence, the barrel structure 90 and handle socket 50 cooperate to functionally define an axle and hub.

As seen clearly in FIG. 4 in which the brush head 20 and brush handle 70 are separated, the lower-wall exterior surface 94 of the barrel structure 90 and the lower socket wall 56 are cooperatively configured (i.e., “complementarily keyed”) to define—and facilitate locking into—each of the first and second angular orientations. More specifically, the lower-wall exterior surface 94 defines at least one each of a barrel protrusion 94ₚ and a barrel recess 94_{R}. Similarly, defined by the lower socket wall 56 is at least one each of a socket protrusion 56ₚ and a socket recess 56R. As explained in the summary, and stated previously in the detailed description, in addition to being rotatable about the brush-head rotation axis A_{BHR}, the mounting of the brush head 20 to the brush handle 70 facilitates selective axial displacement along the brush-head rotation axis A_{BHR} that is constrained between opposed axial first and second positions.

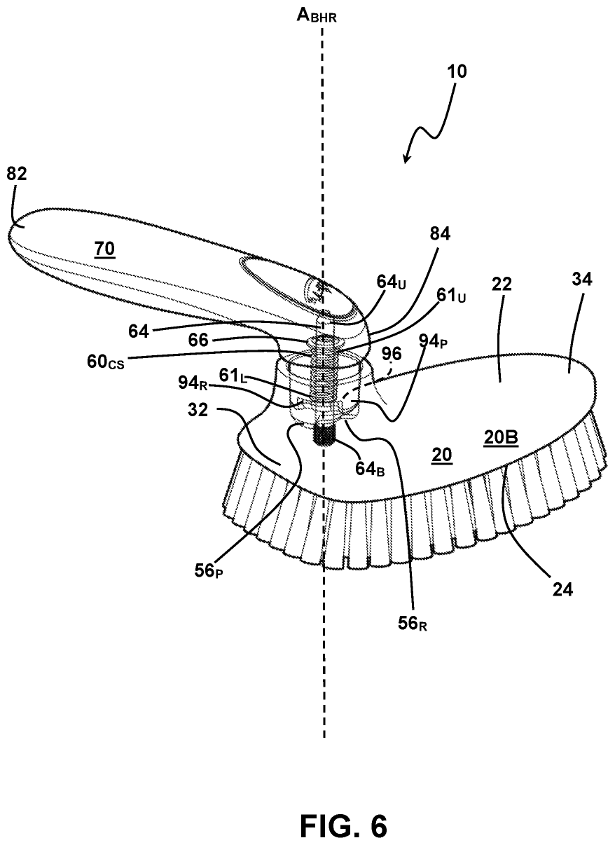

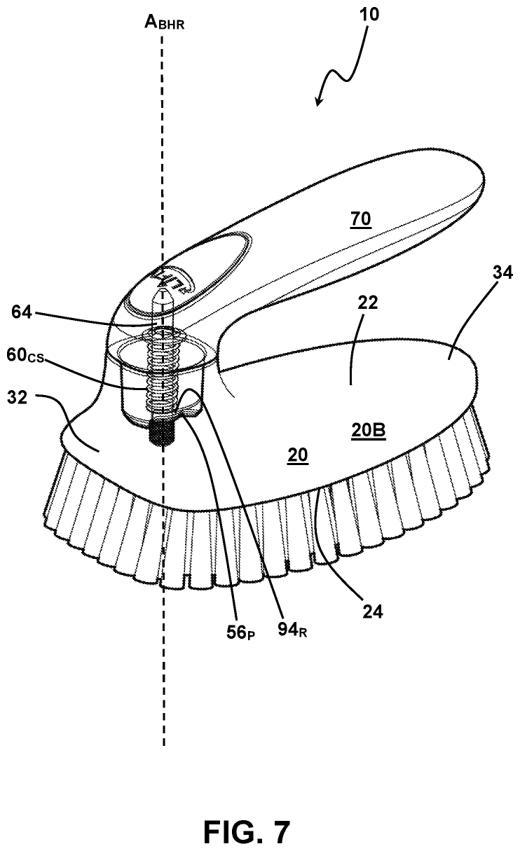

As shown in the assembled, transparent view of FIG. 7, in the axial first position, some combination of at least one barrel protrusion 94ₚ and socket recess 56R and/or at least one socket protrusion 56ₚ and barrel recess 94_{R} are in mutual mating engagement, thereby forming an interference fit between the brush head 20 and brush handle 70 in the first angular orientation. As shown in FIG. 6, the brush handle 20 has been axially displaced into the second axial position in which the combination of at least one barrel protrusion 94ₚ and socket recess 56R and/or at least one socket protrusion 56ₚ and barrel recess 94_{R} are mutually disengaged such that the brush head 20 can be rotated about the brush-head rotation axis A_{BHR} between the first and second angular orientations. Although not shown in a transparent view, when the brush head 20 is rotated into the second angular orientation, as shown in FIG. 2, the brush handle 20 and brush head 70 can be axially displaced into the first axial position in order to lock the brush 10 in the second angular orientation.

In the illustrative embodiment depicted, the first axial position is such that the brush head 20 and brush handle 70 are spatially more proximate one another than they are when they are in the second axial position. Accordingly, the handle 70 is lifted relative to the brush head 70 in order to displace it into the second axial position. It warrants noting that this need not be the case; the first axial position of embodiments within the scope and contemplation of the appended claims—absent express claim limitations to the contrary—may be achieved by lifting the brush handle 70 relative to the brush head 20. However, the latter arrangement would be generally less advantageous given that forces applied in using the brush tend generally to urge the brush handle 70 downward toward the brush head 20. Regardless, for purposes of definitional consistency, the first and second axial positions are always regarded as, respectively, the “engaged position” and the “disengaged position,” and may be alternatively referred to as same in the description and/or claims.

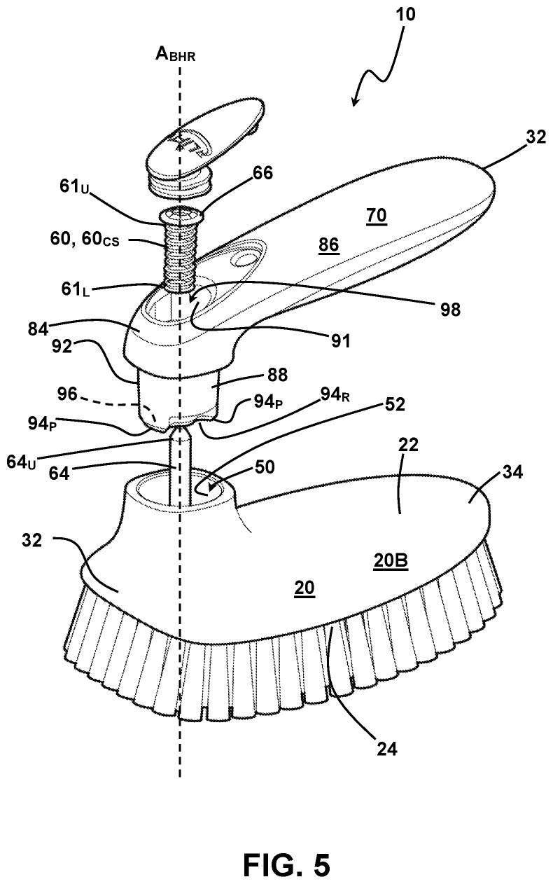

In at least one version, including that shown in FIGS. 5-7, the brush head 20 is normally mechanically biased toward the axial first position (i.e., the engaged position). By “normally,” here is meant “usually” or by default, and not perpendicularly. Accordingly, when the brush head 20 is in the axial first position, an external force axially opposed to the normal mechanical bias must be larger in magnitude along the brush-head rotation axis A_{BHR} in order to displace the brush head 20 into the second axial position and allow rotation of the brush 20 head about the brush-head rotation axis A_{BHR}. The mechanical bias is achieved by a biasing member, such as a spring, an illustrative arrangement of which is subsequently described.

In connection with the illustrative embodiment depicted, there is included, as shown in FIGS. 5-7, a biasing member 60 in the form of a coiled spring 60_{cs} helically disposed about the brush-head rotation axis A_{BHR}. The coiled spring 60_{cs} has mutually opposed spring lower and spring upper ends 61_{L} and 61ᵤ. As indicated in the exploded view of FIG. 5, and shown in FIGS. 6 and 7, the coiled spring 60_{cs} is supported by, and helically disposed about an anchoring pin 64 having pin base and pin upper ends 64B and 64u and being axially centered on the brush-head rotation axis A_{BHR}. The pin base end 64B is anchored into the brush head 20 and extends upwardly through the handle socket 50. Furthermore, when the brush 10 is assembled, the anchoring pin 64 extends through a pin bore BP in the lower-end wall 93 of the brush head mount 88 and upwardly through a pin-and-spring cavity 98 defined within the interior barrel surface 91.

Disposed above the lower-wall interior surface 96 of the barrel structure 90, there is supported by the anchoring pin 64 a spring retainer 66, which is disposed about, and fixed relative to, the anchoring pin 64. The coiled spring 60_{cs} is partially compressed between the spring retainer 66 at the spring upper end 61ᵤ and the lower-wall interior surface 96 of the barrel structure 90 at the spring lower end 61_{L}. According to this arrangement, the coiled spring 60_{cs} acts under compression to mechanically bias the brush handle 70 toward the brush head 20 (i.e., into the engaged axial position) and, when the brush head 20 and handle 70 are in one of the first and second angular orientations, to so maintain them in that position.

In order to disengage the brush head 20 from one of the first and second angular orientations to be rotated into the other of the angular orientation, a user lifts the brush handle 70 relative to the brush head 20, thereby further compressing the coiled spring 60_{cs}. The handle 70 is then rotated at least far enough to cause misalignment between the combination of the at least one barrel protrusion 94ₚ and/or barrel recess 94_{R} and the at least one socket recess 56R and/or socket protrusion 56ₚ that defines whichever of the first and second angular orientations from which the handle 70 has been unlocked. Once sufficient angular misalignment is achieved, the rotation of the brush head 20 relative to the brush handle 70 is then continued—without the need for the user to continue lifting on the handle 70. Once angular alignment of the combination of at least one barrel protrusion 94ₚ and/or barrel recess 94_{R} and the at least one socket recess 56R and/or socket protrusion 56ₚ that defines the other of the first and second angular orientations into which the handle 70 is being rotated has been achieved, the brush head 20 and brush handle 70 are mechanically biased into the engaged position, thereby locking the handle 70 into the other angular orientation.

It will be readily appreciated that the examples discussed and depicted are merely illustrative, and that similar components arranged differently may be configured to achieve the desired functionality described. Less granularly, what matters is that some combination of protrusions and recesses defines at least first and second angular orientations defined and retained by interference fits, thereby preventing relative angular displacement of the brush head 20 and the brush handle 70 about the brush-head rotation axis A_{BHR} as generally described. Similarly, the precise nature and arrangement of mechanisms employed to normally bias the brush head 20 toward the brush-head mount 88 is, in various embodiments, less important than the more general functionality described. Given the benefit of the present disclosure, alternative elements and arrangements of same will occur to one of ordinary skill in the relevant art while remaining within the scope of claims drawn to and encompassing such embodiments.

As mentioned in the summary, the illustrative embodiment depicted in various figures includes a brush head 20 in which the brush-head first and second ends 32 and 34, as well as the bristle array 40 at each of those ends 32 and 34, are disparately configured. Most notably, and with reference to FIG. 4, the brush head 20 and bristle array 40 are wider at the brush-head first end 32 than they are at the brush-head second end 34. More specifically, at the brush-head first end 32, the brush head 20 has a first brush-head width W_{BH1} that is larger than the second brush-head width W_{BH2} at the brush-head second end 34.

While the first and second brush-head widths W_{BH1} and W_{BH2} are labeled only in FIG. 4, it will be readily understood by viewing FIGS. 1 and 2, for example, that, when the brush head 20 is in the first angular orientation so that the brush 10 is configured as a traditional scrub brush—and is held in a user's hand with the handle distal end 84 forward of the handle proximate end 82—the wider portion of the bristle array 40 leads the narrower portion thereof. Among the advantageous of this configuration is that, in a scrubbing configuration, more downward force is typically exerted on the leading bristles 45, and distribution of that force over a larger area and a greater number of bristles 45 is conducive to specific functionality and longevity of the bristles 45. Conversely, when the brush head 20 is in the second angular orientation, the narrower brush-head second end 34, and the bristles 45 thereof, serves as the leading end of the brush 10. This configuration is conducive to accessing corners and crevices while sweeping or washing, for example.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. A reconfigurable brush comprising:
an elongated brush head including a brush-head block defining brush-head upper and lower surfaces extending longitudinally along a brush-head axis between brush-head first and second ends;
a bristle array defined by a plurality of bristles protruding from the brush-head lower surface, each of the bristles terminating in a bristle tip for engaging a work surface;
an elongated brush handle having a lengthwise extent disposed generally along a handle axis between a handle proximate end and a handle distal end disposed forwardly of the handle proximate end, the brush-head first end being mounted to the handle distal end for (a) selective rotation about a brush-head rotation axis between first and second angular orientations and (b) selective axial displacement along the brush-head rotation axis between axial first and second positions, wherein
(i) in the first angular orientation, the brush-head second end is disposed rearwardly of the brush-head first end and the handle distal end;
(ii) in the second angular orientation, the brush-head second end is disposed forwardly of the brush-head first end and the handle distal end;
(iii) in the axial first position, the brush head is engaged in an interference fit with the brush handle in one of the first and second angular orientations; and
(iv) in the axial second position, the brush head is disengaged from the interference fit with the brush handle such that the brush head can be rotated about the brush-head rotation axis between the first and second angular orientations.

2. The reconfigurable brush of claim 1 wherein the brush head is normally mechanically biased toward the axial first position such that an external force axially opposed to the normal mechanical bias must be larger in magnitude along the brush-head rotation axis to displace the brush head into the second axial position and allow rotation of the brush head about the brush-head rotation axis.

3. The reconfigurable brush of claim 2 wherein the first and second angular orientations are mutually opposed at an angle of 180 degrees.

4. The reconfigurable brush of claim 3 wherein (a) disposition of the brush head in the first angular orientation corresponds to the reconfigurable brush being in a traditional scrub brush configuration in which a majority of the lengthwise extent of the brush head is disposed beneath a majority of the lengthwise extent of the brush handle and (b) disposition of the brush head in the second angular orientation corresponds to the reconfigurable brush being in an elongated brush configuration in which a majority of the lengthwise extent of the brush head is disposed forwardly of a majority of the lengthwise extent of the brush handle.

5. The reconfigurable brush of claim 2 wherein (a) disposition of the brush head in the first angular orientation corresponds to the reconfigurable brush being in a traditional scrub brush configuration in which a majority of the lengthwise extent of the brush head is disposed beneath a majority of the lengthwise extent of the brush handle and (b) disposition of the brush head in the second angular orientation corresponds to the reconfigurable brush being in an elongated brush configuration in which a majority of the lengthwise extent of the brush head is disposed forwardly of a majority of the lengthwise extent of the brush handle.

6. The reconfigurable brush of claim 1 wherein (a) disposition of the brush head in the first angular orientation corresponds to the reconfigurable brush being in a traditional scrub brush configuration in which a majority of the lengthwise extent of the brush head is disposed beneath a majority of the lengthwise extent of the brush handle and (b) disposition of the brush head in the second angular orientation corresponds to the reconfigurable brush being in an elongated brush configuration in which a majority of the lengthwise extent of the brush head is disposed forwardly of a majority of the lengthwise extent of the brush handle.

7. The reconfigurable brush of claim 6 wherein the first and second angular orientations are mutually opposed at an angle of 180 degrees.

8. A reconfigurable brush comprising:
an elongated brush head including a brush-head block defining brush-head upper and lower surfaces extending longitudinally along a brush-head axis between brush-head first and second ends;
a bristle array defined by a plurality of bristles protruding from the brush-head lower surface, each of the bristles terminating in a bristle tip for engaging a work surface;
an elongated brush handle having a lengthwise extent disposed generally along a handle axis between a handle proximate end and a handle distal end disposed forwardly of the handle proximate end, the brush-head first end being mounted to the handle distal end for (a) selective rotation about a brush-head rotation axis between first and second angular orientations mutually opposed at an angle of 180 degrees and (b) selective axial displacement along the brush-head rotation axis between axial first and second positions, wherein
(i) in the first angular orientation, the brush-head second end is disposed rearwardly of the brush-head first end and the handle distal end;
(ii) in the second angular orientation, the brush-head second end is disposed forwardly of the brush-head first end and the handle distal end;
(iii) in the axial first position, the brush head is engaged in an interference fit with the brush handle in one of the first and second angular orientations;
(iv) in the axial second position, the brush head is disengaged from the interference fit with the brush handle such that the brush head can be rotated about the brush-head rotation axis between the first and second angular orientations; and
(v) the brush head is normally mechanically biased toward the axial first position by a biasing member in the form of a coiled spring.

9. The reconfigurable brush of claim 8 wherein (a) disposition of the brush head in the first angular orientation corresponds to the reconfigurable brush being in a traditional scrub brush configuration in which a majority of the lengthwise extent of the brush head is disposed beneath a majority of the lengthwise extent of the brush handle and (b) disposition of the brush head in the second angular orientation corresponds to the reconfigurable brush being in an elongated brush configuration in which a majority of the lengthwise extent of the brush head is disposed forwardly of a majority of the lengthwise extent of the brush handle.

10. The reconfigurable brush of claim 9 wherein the brush head and bristle array are wider at the brush-head first end than at the brush-head second end.

11. The reconfigurable brush of claim 9 further comprising
a brush-head mount that at least partially defines the handle distal end and includes a barrel structure with an exterior cylindrical mounting surface and a lower-end wall having a lower-wall exterior surface, the cylindrical mounting surface being axially centered about, and partially defining, the brush-head rotation axis; and
a handle socket defined within the brush-head upper surface and including an interior cylindrical socket surface and a lower socket wall, the cylindrical socket surface being configured to receive and retain the cylindrical mounting surface of the brush-head mount in a manner that facilitates relative rotation and axial displacement of the barrel structure and the cylindrical socket surface while preventing relative lateral motion between the barrel structure and the handle socket, wherein
the barrel structure and handle socket cooperate to functionally define an axle and hub that facilitates rotation of the brush head between the first and second angular orientations and mutual axial displacement of the handle and brush head between the axial first and second positions.

12. The reconfigurable brush of claim 11 wherein the lower-wall exterior surface of the barrel structure and the lower socket wall are cooperatively configured to define, and facilitate locking of the brush head into, each of the first and second angular orientations.

13. The reconfigurable brush of claim 12 wherein the brush head and bristle array are wider at the brush-head first end than at the brush-head second end.
